(19) United States
(12) Patent Application Publication
(10) Pub. No.: US 2006/0170715 A1
(43) Pub. Date: Aug. 3, 2006

(54) Digital image printing system, printing apparatus, method of controlling digital image printing system, method of controlling printing apparatus, and computer product

(76) Inventor: Katsuyuki Toda, Tokyo (JP)

Correspondence Address: HARNESS, DICKEY & PIERCE, P.L.C., P.O. BOX 8910, RESTON, VA, 20195, US

(21) Appl. No.: 11/340,684

(22) Filed: Jan. 27, 2006

(30) Foreign Application Priority Data
Jan. 28, 2005 (JP) 2005-020977

(51) Int. Cl. B41J 3/00

(52) U.S. Cl. 347/2

(57) ABSTRACT

An external apparatus transmits a size of a print sheet and at least one digital image data to a printing apparatus. Upon receiving the size and the at least one digital image data, the printing apparatus selects, a tray in which a print sheet of an actual sheet type with a highest priority from among a plurality of trays in which the print sheet of a same size as the received size by referring to the paper-type priority table and the paper-type combination table stored in a storing unit, and prints an image of the received digital image data on the print sheet fed from the selected tray.

### CROSS-REFERENCE TO RELATED APPLICATIONS

The present document incorporates by reference the entire contents of Japanese priority document, 2005-020977 filed in Japan on Jan. 28, 2005.

### BACKGROUND OF THE INVENTION

1. Field of the Invention

The present invention relates to a digital image printing system, a printing apparatus, a method of controlling the digital image printing system, a method of controlling the printing apparatus for realizing a digital printing.

2. Description of the Related Art

Conventionally, there is a digital still camera that stores a photographed digital image in a storage medium and has a function of making connection to an external apparatus and exchanging data with the external apparatus. With the digital still camera, in outputting to print the photographed digital image on a paper medium, a user once sends the digital image stored in the storage medium to an external data apparatus like a personal computer and prints the digital image from a printing apparatus using an edition printing function (application) of the external data apparatus.

Alternatively, the user removes the storage medium of the digital still camera and prints the digital image stored in the storage medium using a service at a DPE shop or a printer for a digital still camera in the shop.

When the user prints a digital image obtained by photographing a subject with the digital still camera in this way, it is not convenient for the user to print the digital image because an external storage and the like are required.

Thus, a printing apparatus that has a function of making connection to a digital still camera and exchanging data with the digital still camera to make it possible to print image data received from the digital camera has been put to practical use.

Such a function of the printing apparatus is called a direct print function.

It is possible to conveniently print a digital image obtained by photographing a subject with the digital camera by using the printing apparatus having the direct print function.

However, in using the direct print function, the user performs operation using a display unit and an operating unit provided in the digital still camera. Thus, compared with printing using the external data apparatus, for example, since a degree of freedom of printing in a layout or the like is low, only a relatively simple print can be obtained.

Thus, for example, Japanese Patent Application Laid-Open No. 2004-64740 proposes a technology that makes it possible to improve consistency of print jobs among digital still cameras manufactured by different manufactures by transmitting print information of a printer to the digital still cameras when the printer and the digital still cameras are connected.

However, in the technology disclosed in Japanese Patent Application Laid-Open No. 2004-64740, for example, sheet types set in sheet feeding trays of the printer are transmitted as the print information. The sheet types are limited only to general sheet types for a so-called ink-jet printer like plain paper and glossy paper for photographs.

As a result, the user cannot enjoy convenience of abundant sheet types in the direct print with the digital camera even if the user uses a printing apparatus, such as a laser beam printer or a multifunction product, that is not intended to handle paper aiming mainly at a high photograph image quality.

In a system having the direct print function, it is also possible to output an image on a sheet of a sheet type set in the printing apparatus by not designating a sheet type from the digital still camera or designating a default format of the printing apparatus. However, in such a system, the user is forced to switch a sheet type every time the user performs printing. Thus, convenience for the user is deteriorated.

### SUMMARY OF THE INVENTION

It is an object of the present invention to at least solve the problems in the conventional technology.

A digital image printing system according to one aspect of the present invention is built with an external apparatus and a printing apparatus. The external apparatus stores digital image data, makes a connection to the printing apparatus, and exchanges data with the printing apparatus. The printing apparatus prints image data received from the external apparatus. The external apparatus transmits a size of a print sheet and at least one digital image data to the printing apparatus. The printing apparatus includes a feeding unit that includes a plurality of trays for storing the print sheet; and a storing unit that stores a paper-type priority table in which a priority of selection is allocated to a reference sheet type representing a sheet type of the print sheet to be used and a paper-type combination table in which at least one relation between the reference sheet type and an actual sheet type is listed. Upon receiving the size of the print sheet and the at least one digital image data from the external apparatus, the printing apparatus selects, a tray in which a print sheet of an actual sheet type with a highest priority from among trays in which the print sheet of a same size as the received size by referring to the paper-type priority table and the paper-type combination table, and prints an image of the received digital image data on the print sheet fed from the selected tray.

A printing apparatus according to another aspect of the present invention makes a connection to an external apparatus to exchange data, and prints image data received from the external apparatus. The printing apparatus includes a feeding unit that includes a plurality of trays for storing the print sheet; and a storing unit that stores a paper-type priority table in which a priority of selection is allocated to a reference sheet type representing a sheet type of the print sheet to be used and a paper-type combination table in which at least one relation between the reference sheet type and an actual sheet type is listed. Upon receiving a size of the print sheet and at least one digital image data from the external apparatus, the printing apparatus selects, a tray in which a print sheet of an actual sheet type with a highest priority from among trays in which the print sheet of a same size as the received size by referring to the paper-type priority table and the paper-type combination table, and prints an image of the received digital image data on the print sheet fed from the selected tray.

A method according to still another aspect of the present invention is for controlling a digital image printing system built with an external apparatus and a printing apparatus. The external apparatus stores digital image data, makes a connection to the printing apparatus, and exchanges data with the printing apparatus. The printing apparatus prints image data received from the external apparatus. The method includes transmitting including the external apparatus transmitting a size of a print sheet and at least one digital image data to the printing apparatus; and printing including the printing apparatus storing a paper-type priority table in which a priority of selection is allocated to a reference sheet type representing a sheet type of the print sheet to be used and a paper-type combination table in which at least one relation between the reference sheet type and an actual sheet type is listed, the printing apparatus selecting, upon receiving the size of the print sheet and the at least one digital image data from the external apparatus, a tray in which a print sheet of an actual sheet type with a highest priority from among a plurality of trays in which the print sheet of a same size as the received size by referring to the paper-type priority table and the paper-type combination table, and the printing apparatus printing an image of the received digital image data on the print sheet fed from the selected tray.

A method according to still another aspect of the present invention is for controlling a printing apparatus that makes a connection to an external apparatus to exchange data, and prints image data received from the external apparatus. The method includes storing a paper-type priority table in which a priority of selection is allocated to a reference sheet type representing a sheet type of a print sheet to be used and a paper-type combination table in which at least one relation between the reference sheet type and an actual sheet type is listed; selecting, upon receiving a size of the print sheet and at least one digital image data from the external apparatus, a tray in which a print sheet of an actual sheet type with a highest priority from among a plurality of trays in which the print sheet of a same size as the received size by referring to the paper-type priority table and the paper-type combination table; and printing an image of the received digital image data on the print sheet fed from the selected tray.

A computer-readable recording medium according to still another aspect of the present invention stores a computer program for controlling a printing apparatus that makes a connection to an external apparatus to exchange data, and prints image data received from the external apparatus. The computer program causes a computer to execute storing a paper-type priority table in which a priority of selection is allocated to a reference sheet type representing a sheet type of a print sheet to be used and a paper-type combination table in which at least one relation between the reference sheet type and an actual sheet type is listed; selecting, upon receiving a size of the print sheet and at least one digital image data from the external apparatus, a tray in which a print sheet of an actual sheet type with a highest priority from among a plurality of trays in which the print sheet of a same size as the received size by referring to the paper-type priority table and the paper-type combination table; and printing an image of the received digital image data on the print sheet fed from the selected tray.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are block diagrams of a digital still camera printing system according to an embodiment of the present invention;

FIG. 2 is a block diagram of an example of a constitution of a digital still camera DSC;

FIG. 3 is a block diagram of an example of a constitution of a printing apparatus PTR;

FIG. 4 is a block diagram of an example of a constitution of an image storing apparatus DST;

FIG. 5 is a timing chart of an example of a communication procedure at the time when the digital still camera DSC or the image storing apparatus DST instructs the printing apparatus PTR to print an image;

FIG. 6A is a table of an example of print job information;

FIG. 6B is a table of an example of a format of image data;

FIG. 7 is an example of a paper-type priority table;

FIG. 8 is an example of a paper-type combination table;

FIG. 9 is a flowchart of an example of processing at the time when the digital still camera DSC (or the image storing apparatus DST) communicates with the printing apparatus PTR and transfers image data desired to be printed to the printing apparatus PTR;

FIG. 10 is a flowchart of an example of processing of the printing apparatus PTR at the time when the printing apparatus PTR receives a printing service request from the digital still camera DSC or the image storing apparatus DST;

FIG. 11 is a flowchart of the example of processing of the printing apparatus PTR at the time when the printing apparatus PTR receives a printing service request from the digital still camera DSC or the image storing apparatus DST;

FIG. 12 is a flowchart of an example of tray search processing; and

FIG. 13 is a flowchart of an example of tray search processing.

### DETAILED DESCRIPTION OF THE PREFERRED EMBODIMENTS

Exemplary embodiments of the present invention are described below in detail with reference to the accompanying drawings.

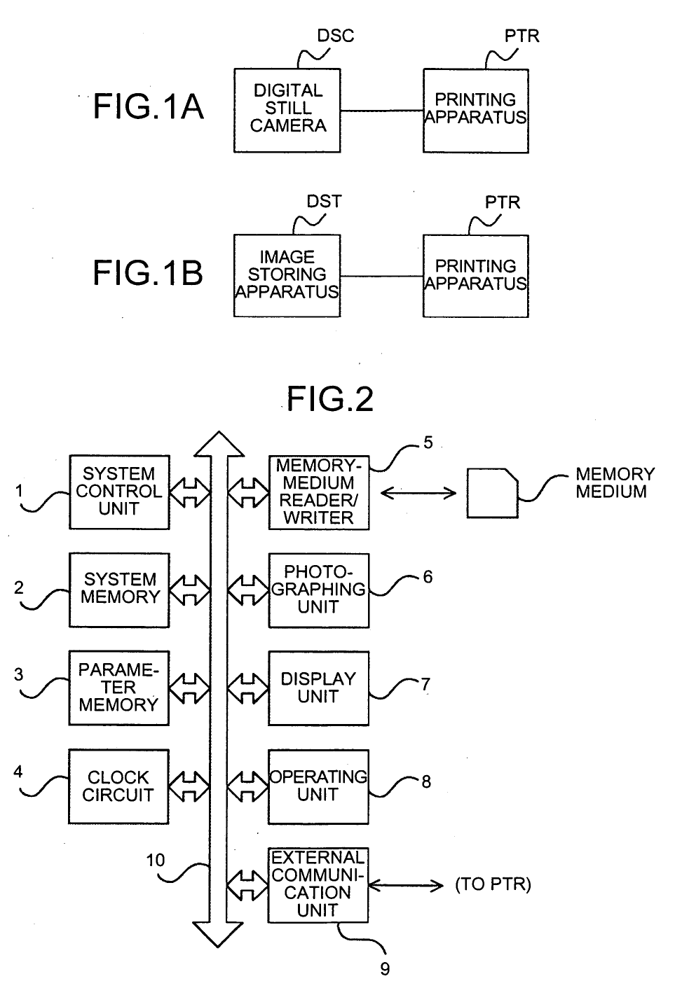

FIGS. 1A and 1B are block diagrams of a digital still camera printing system according to an embodiment of the present invention. In this case, a digital still camera DSC is connected to a printing apparatus PTR as an external apparatus of the printing apparatus PTR.

The digital still camera DSC stores digital image data obtained by photographing a subject in a memory medium (a storage medium; described later) and has a function of making connection to the printing apparatus PTR and transferring a sheet size of a printing sheet, an arrangement layout of an image, selected one or more image data, and the like to the printing apparatus PTR according to a predetermined communication procedure.

The printing apparatus PTR receives the sheet size, the arrangement layout of an image, and the one or more image data from the digital still camera DSC. The printing apparatus PTR selects a tray, from which sheets are fed, according to the sheet size and the arrangement layout of an image and outputs to print an image of the image data received on the sheet fed from the tray selected.

The digital still camera DSC includes an external communication unit for making connection to an external apparatus such as the printing apparatus PTR to exchange data. As the external communication unit, the digital still camera DSC includes a genera-purpose communication unit like a Universal Serial Bus (USB).

As shown in FIG. 1B, it is also possible to connect an image storing apparatus DST to the printing apparatus PTR instead of the digital still camera DSC and output to print an image stored in the image storing apparatus DST with the printing apparatus PTR.

Therefore, the image storing apparatus DST has a function of making connection to the printing apparatus PTR and transferring the sheet size of a printing sheet, the arrangement layout of an image, the selected one or more image data, and the like to the printing apparatus PTR according to the predetermined communication procedure.

FIG. 2 is a diagram of an example of a constitution of the digital still camera DSC.

A system control unit 1 performs operation control for units of the digital still camera DSC, data readout/writing control for a memory medium MC, photographing control, communication control for communication between the digital still camera DSC and an external apparatus performed via an external communication unit, and various kinds of data processing such as various user interface processing at the time when a user operates the digital still camera DSC. A system memory 2 stores various control programs executed by the system control unit 1 and constitutes a work area for the system control unit 1. A parameter memory 3 stores various kinds of information peculiar to the digital still camera DSC. A clock circuit 4 outputs present time information and the like.

A memory-medium reader/writer 5 is detachably attached with the memory medium MC and reads out data from and writes data in the memory medium MS attached. A photographing unit 6 includes a camera mechanism, an optical system, and a photoelectric conversion unit for camera photographing. A display unit 7 displays various kinds of information for the user and includes a liquid crystal display device. An operating unit 8 is used by the user to operate the digital still camera DSC and includes various keys and the like.

An external communication unit 9 includes a general-purpose communication unit such as a Universal Serial Bus (USB) and makes connection to external apparatuses such as the printing apparatus PTR and the image storing apparatus DST to exchange data with the external apparatuses.

The system control unit 1, the system memory 2, the parameter memory 3, the clock circuit 4, the memory-medium reader/writer 5, the photographing unit 6, the display unit 7, the operating unit 8, and the external communication unit 9 are connected to an internal bus 10. Exchange of data among the units is performed mainly via the internal bus 10.

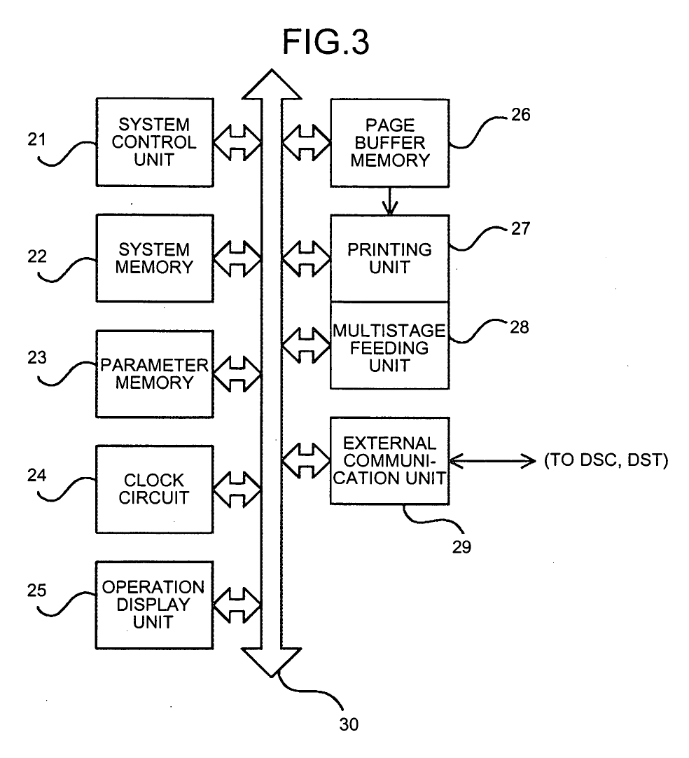

FIG. 3 is a diagram of an example of a constitution of the printing apparatus PTR. The printing apparatus PTR includes a multistage feeding unit including a plurality of trays that store sheets.

A system control unit 21 performs operation control for units of the printing apparatus PTR, sheet feeding control, printing control, communication control for communication between the printing apparatus PTR and an external apparatus performed via an external communication unit, and various kinds of data processing such as various kinds of user interface processing when the user operates the printing apparatus PTR. A system memory 22 stores various control programs executed by the system control unit 21 and constitutes a work area for the system control unit 21. A parameter memory 23 stores various kinds of information peculiar to the printing apparatus PTR. A clock circuit 24 outputs present time information and the like. An operation display unit 25 constitutes a user interface used by the user to operate the printing apparatus PTR.

A page buffer memory 26 constitutes a frame memory that stores print data for one page. A printing unit 27 reads out the print data from the frame memory constituted in the page buffer memory 26 and prints an image on a sheet. A multistage feeding unit 28 including a plurality of trays storing sheets is annexed to the printing unit 27. This makes it possible to select an appropriate sheet from a plurality of kinds of sheets and adopt the sheet as a recording sheet used by the printing unit 27. Examples of the sheets stored in the trays include A4 plain paper, A4 recycled paper, A4 special paper, B5 plain paper, B5 recycled paper, B5 special paper, A3 plain paper, A3 recycled paper, and A3 special paper.

An external communication unit 29 includes a general-purpose communication unit such as a Universal Serial Bus (USB) and makes connection to external apparatuses such as the digital still camera DSC and the image storing apparatus DST to exchange data with the external apparatuses.

The system control unit 21, the system memory 22, the parameter memory 23, the clock circuit 24, the operation display unit 25, the page buffer memory 26, the printing unit 27, the multistage feeding unit 28, and the external communication unit 29 are connected to an internal bus 30. Exchange of data among the units is performed mainly via the internal bus 30.

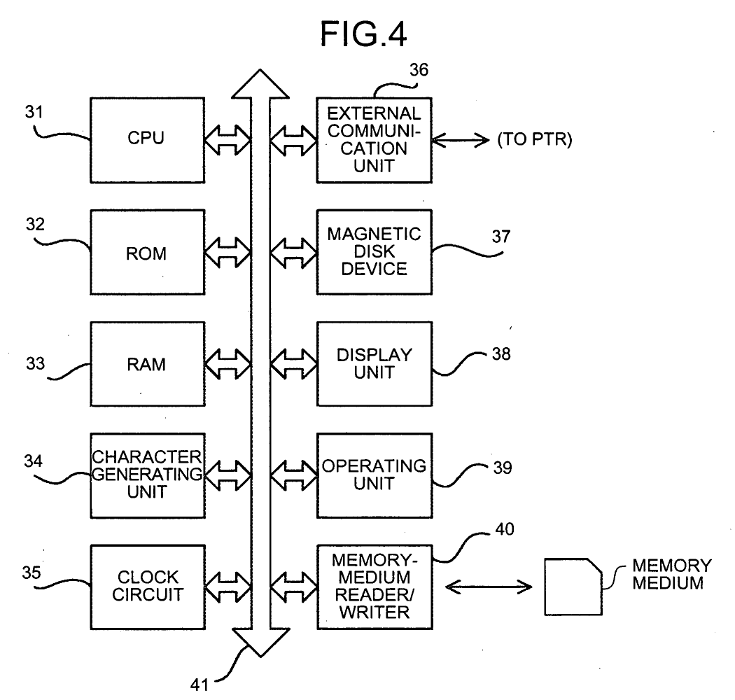

FIG. 4 is a diagram of an example of a constitution of the image storing apparatus DST. The image storing apparatus DST captures to store a large number of image data stored in a memory medium and has a function of, for example, displaying the stored image data and transferring the image data to an external apparatus.

A central processing unit (CPU) 31 performs operation control for the image storing apparatus DST. A read only memory (ROM) 32 stores a program executed by the CPU 31 at the time of startup, necessary data, and the like. A random access memory (RAM) 33 constitutes a work area for the CPU 21.

A character generating unit 34 generates display data of figures and characters. A clock circuit 35 outputs present time information. An external communication unit 36 includes a general-purpose communication unit such as a Universal Serial Bus (USB) and connects the image storing apparatus DST to an external apparatus such as the printing apparatus PTR.

A magnetic disk device 37 stores various data such as a large number of image data. A display unit 38 displays various kinds of information for the user and includes a liquid crystal display device. An operating unit 39 is used by the user to operate the image storing apparatus DST and includes various keys. A memory-medium reader/writer 40 is detachably attached with a memory medium MC and reads out data from and writes data in the memory medium MC attached.

The CPU 31, the ROM 32, the RAM 33, the character generating unit 34, the clock circuit 35, the external communication unit 36, the display unit 38, the operating unit 39, and the memory-medium reader/writer 40 are connected to an internal bus 41. Exchange of data among the units is performed mainly via the internal bus 41.

A mobile communication terminal (such as “cellular phone”, etc.) having the function of the digital still camera DSC or the image storing apparatus DST is also put to practical use. It is also possible to use such a mobile communication terminal instead of the digital still camera DSC or the image storing apparatus DST. It is also possible to use a digital video camera having a digital still camera function.

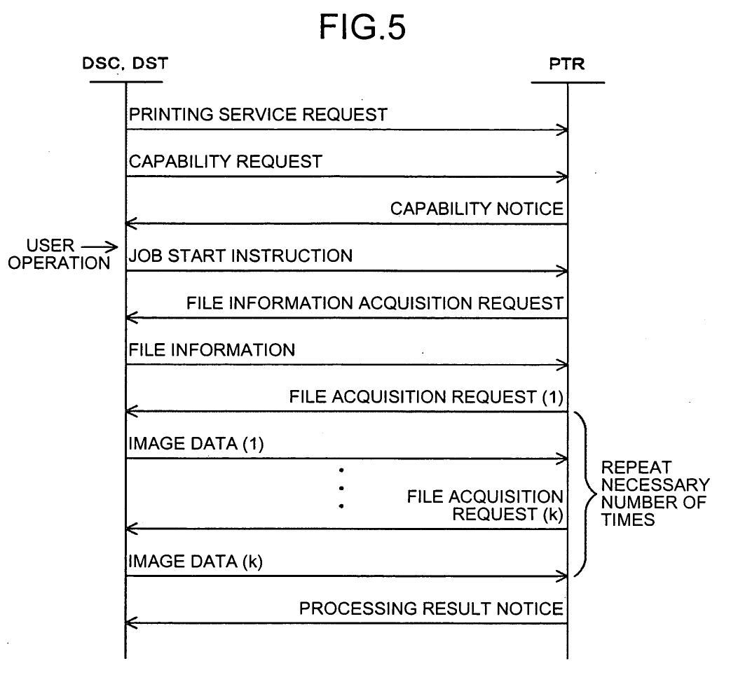

FIG. 5 is a diagram of an example of a communication procedure at the time when the digital still camera DSC or the image storing apparatus DST instructs the printing apparatus PTR to print an image.

A user connects the digital still camera DSC or the image storing apparatus DST and the printing apparatus PTR using a USB cable and instructs the digital still camera DSC or the image storing apparatus DST to print an image.

According to the instruction, the digital still camera DSC or the image storing apparatus DST transmits a command “printing service request” to the printing apparatus PTR and subsequently transmits a command “capability request” to the printing apparatus PTR.

When the printing apparatus PTR receives the command “capability request”, the printing apparatus PTR transmits a response “capability notice” including capability information that can be designated at the time of printing in the printing apparatus PTR itself.

Examples of the capability information include output qualities (high speed, normal quality, high quality, etc.), sheet types (plain paper, recycled paper, special paper (an overhead projector transparency, backing paper, color paper, etc.), etc.), sheet sizes (information indicating size types of cut paper (fixed form); e.g., A3, A4 , B4, and B5), acceptable image formats, date output, and the number of aggregated images (layout information with respect to a sheet size). The “number of aggregated images” indicates the number of frames (the number of images) per one sheet that can be designated in selecting an aggregate layout that is an arrangement layout of a form of arranging a plurality of images on one sheet.

Consequently, according to the capability information notified by the printing apparatus PTR, the digital still camera DSC or the image storing apparatus DST prompts the user to input print conditions (an output quality, a sheet size, a sheet type, presence or absence of date output, the number of aggregated images, index printing, etc.) and select an image to be printed.

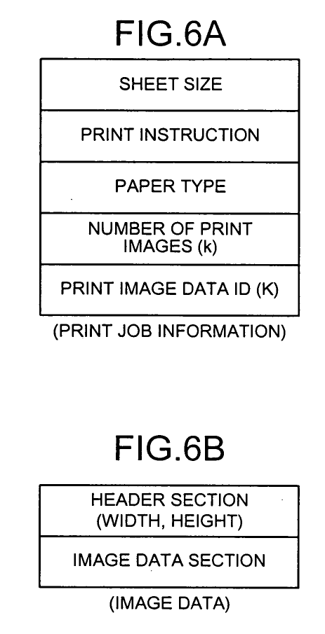

When the user ends the operation, the digital still camera DSC or the image storing apparatus DST transmits a command “job start instruction” including print job information shown in FIG. 6A to the printing apparatus PTR. The print job information includes a sheet size, a sheet type, a print instruction (print layout (one frame per one sheet, a plurality of frames per one sheet, etc.) instruction, index printing, etc.), the number of print images (k), and print image data IDs (k). The print job information does not include information designating the sheet type in some cases. A default value may be designated as the sheet type.

The printing apparatus PTR sequentially designates one or more print image data IDs included in the print job information received and transmits one or more responses “file acquisition request” to the digital still camera DSC or the image storing apparatus DST.

According to the response, the digital still camera DSC or the image storing apparatus DST transmits image data of the print image data IDs designated to the printing apparatus PTR one by one.

The printing apparatus PTR selects a sheet to be used for printing according to the sheet size included in the received print job information and forms print data based on the image data received to appropriately perform a print operation as required. Because the image data is received in an encoded formin any one of the image formats, the printing apparatus PTR decodes the image format to create, for example, image data of an RGB format and converts the image data of the RGB format into print data. In this case, the printing apparatus PTR appropriately subjects an image to be printed to magnification processing according to a relation between a size (resolution and the number of pixels) of the image data and a size of the sheet used for printing or a printing area.

When the printing apparatus PTR ends all print operations, the printing apparatus PTR transmits a result of the print operations to the digital still camera DSC or the image storing apparatus DST as a response “processing result notice”.

When the digital still camera apparatus DSC or the image storing apparatus DST receives the response “processing result notice” from the printing apparatus PTR, the digital still camera apparatus DSC or the image storing apparatus DST ends the print job.

In a communication protocol described above, the number of print images is included in the print job information. However, since it is possible to obtain the number of print images by counting the number of print image data IDs of print job information in the printing apparatus PTR, the number of print images does not have to be included in the print job information.

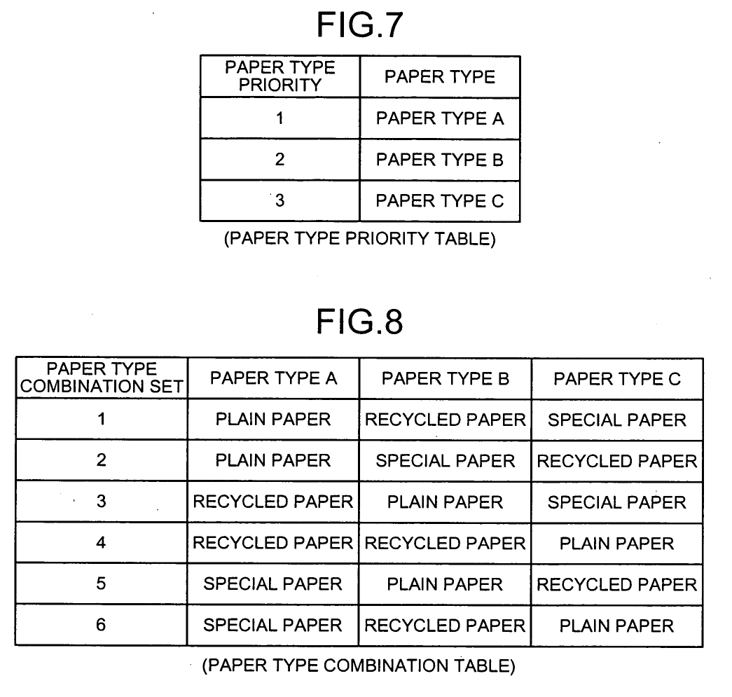

According to the present embodiment, three sheet types A, B, C are adopted as types of sheets to be used. A paper-type priority table defining priorities of selection of the sheet types is registered. An example of the paper-type priority table is shown in FIG. 7.

A paper-type combination table shown in FIG. 8 is provided to allow the user to arbitrarily allocate types of actual paper (hereinafter, “actual sheet types”) to the sheet types A, B, and C (hereinafter, “reference sheet types”). Plain paper, recycled paper, and special paper (e.g., an overhead projector transparency, backing paper, color paper, and thick paper) are adoptable as the actual sheet types.

The user can appropriately perform setting registration of the actual sheet types for the sheets stored in the respective trays of the multistage feeding unit 28 using the operation display unit 25.

The actual sheet types are not limited to the plain paper, the recycled paper, and the special paper and may be set for use as required.

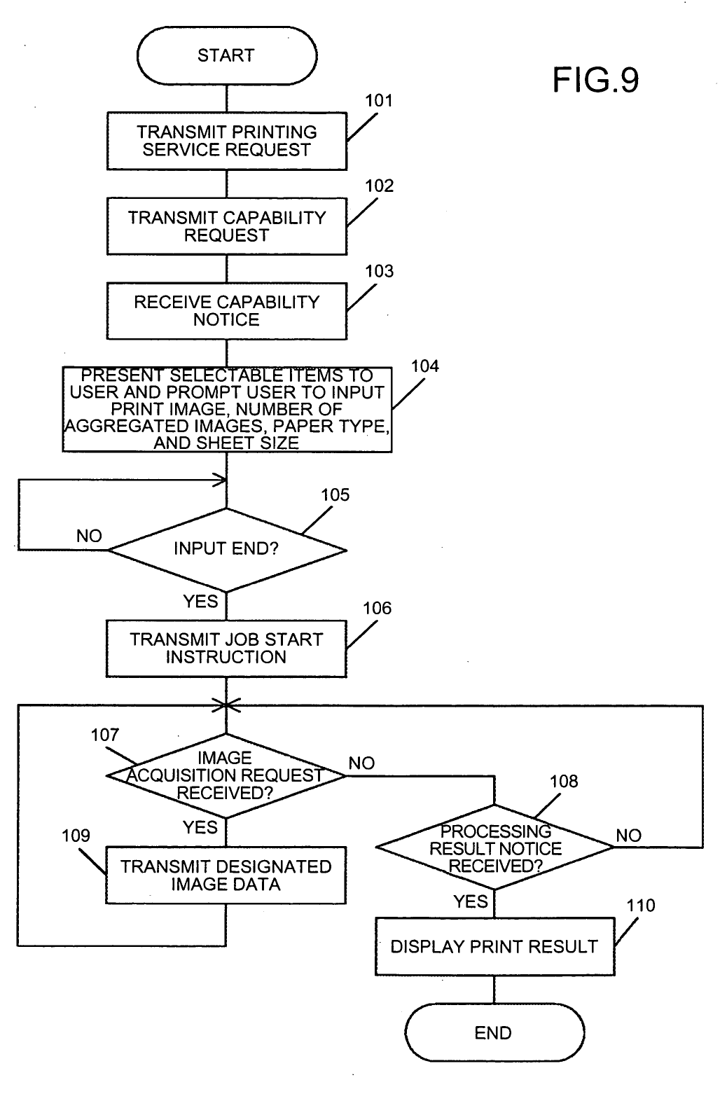

FIG. 9 is a flowchart of an example of processing at the time when the digital still camera DSC (or the image storing apparatus DST) communicates with the printing apparatus PTR and transfers image data desired to be printed to the printing apparatus PTR.

A user connects the digital still camera DSC and the printing apparatus PTR using a USB cable and instructs the digital still camera DSC to print an image.

According to the instruction, the digital still camera DSC transmits a command “printing service request” to the printing apparatus PTR (step S101) and subsequently transmits a command “capability request” to the printing apparatus PTR (step S102).

Since a response “capability notice” is sent from the printing apparatus PTR, the digital still camera DSC receives the response ”capability notice” (step S103) and, according to capability information included in the response “capability notice” received, prompts the user to input print conditions (an output quality, a sheet size, a sheet type, presence or absence of date output, the number of aggregated images, etc.) and select an image to be printed (step S104).

When the user ends the operation (“YES” at step S105), the digital still camera DSC transmits a command “job start instruction” including the print job information (see FIG. 6A) to the printing apparatus PTR (step S106). When a sheet type is not clearly designated at step S104, a sheet type is not included in the print job information. When a “default value” is present in options of sheet types, if the user selects the default value, information indicating the default value is included as a sheet type.

After transmitting the command “job start instruction”, the digital still camera DSC receives a response “file acquisition request” from the printing apparatus PTR or waits for receiving a response “processing result notice” (a loop of “NO” at steps S107 and S108).

When the digital still camera DSC receives the response “file acquisition request” and a result of judgment at step S107 is “YES”, the digital still camera DSC reads out image data of a designated print image data ID and transmits the image data to the printing apparatus PTR (step S109).

When the digital still camera DSC receives the response “processing result notice” and a result of judgment at step S108 is “YES”, the digital still camera DSC outputs to display a print result (step S110) and ends the operation.

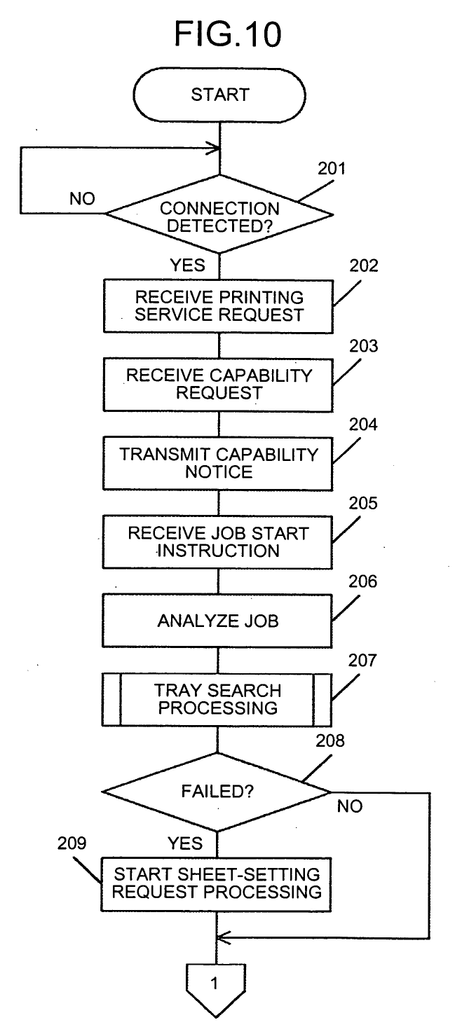

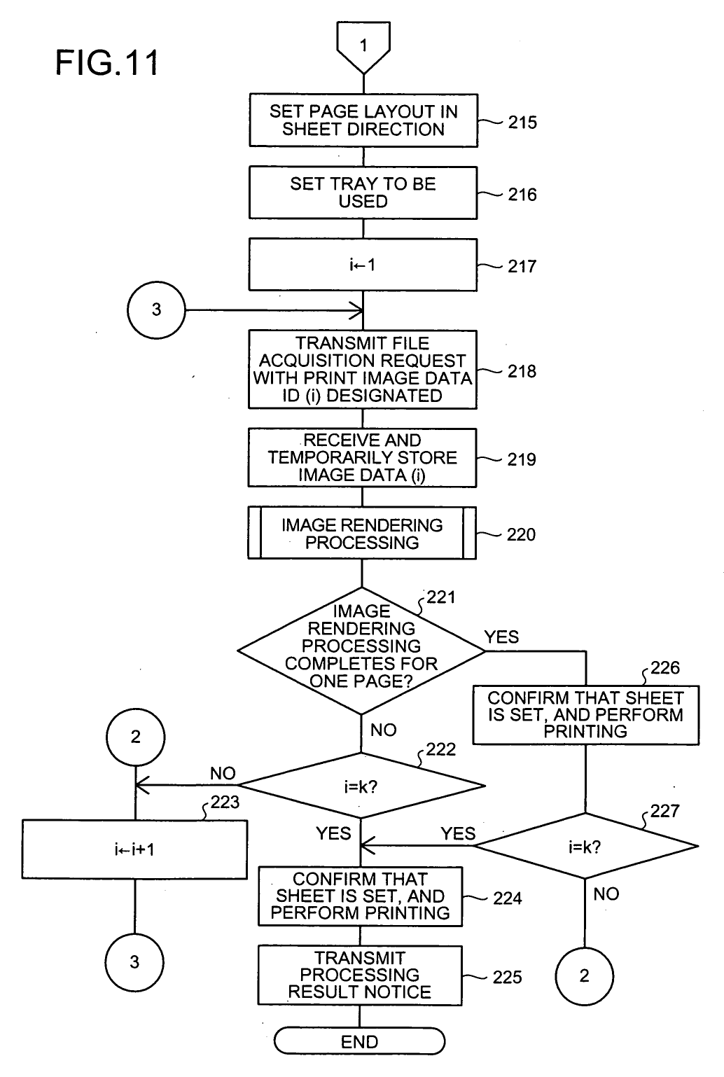

FIGS. 10 and 11 are flowcharts of an example of processing by the printing apparatus PTR at the time when the printing apparatus PTR receives a printing service request from the digital still camera DSC or the image storing apparatus DST.

When the printing apparatus PTR detects connection of the USB cable (“YES” at step S201), the printing apparatus PTR receives a command “printing service request” from the destination terminal (step S202). Subsequently, when the printing apparatus PTR receives a command “capability request” (step S203), the printing apparatus PTR transmits a response “capability notice” including the capability information described above (step S204).

When the printing apparatus PTR receives a command “job start instruction” (step S205), the printing apparatus PTR analyzes content of the command “job start instruction” (step S206), searches for a tray storing sheets to be used for printing from the multistage feeding unit 28, and sets the tray as a tray to be used (step S207, tray search processing).

The printing apparatus PTR checks whether the search for a tray to be used has failed in the tray search processing at step S207 (step S208). When a result at step S208 is “YES”, the printing apparatus PTR starts sheet-setting request processing for requesting the user to set sheets of a sheet size designated by the destination terminal in the multistage feeding unit 28 (step S209) and executes processing following step S209. When a tray to be used is successfully found in the tray search processing (step S207) and a result of judgment at step S208 is “NO”, the printing apparatus PTR does not execute step S209 and executes the processing following step S209.

The printing apparatus PTR sets a page layout (“lengthwise” or “sideways”) corresponding to a sheet direction of the sheets stored in the selected tray of the multistage feeding unit 28, secures a frame memory of the page layout in the page buffer memory 26 (step S215), and sets the selected tray as a tray to be used in the multistage feeding unit 28 (step S216).

When the setting of the tray ends in this way, the printing apparatus PTR initially sets a counter i for holding the number of print images to 1 (step S217) and transmits a response “file acquisition request” designating ith print image data ID (i) to the destination terminal (step S218).

Subsequently, since the destination terminal transmits ith image data (i), the printing apparatus PTR receives and temporarily stores the ith image data (i) (step S219) and writes print data corresponding to the image data in the frame memory secured in the page buffer memory 26 (image rendering processing; step S220).

The printing apparatus PTR judges whether print data of images of the number of aggregated images (one or two or more) for one page is written in the frame memory (step S221). When a result of judgment at step S221 is “NO”, the printing apparatus PTR checks whether a value of the counter i is equal to the number of images k (step S222).

When a result of judgment at step S221 is “NO”, to store the image data in a remaining image area of a page under processing, the printing apparatus PTR increments the value of the counter i by one (step S223) and returns to step S218. When a result of judgment at step S222 is “YES”, the printing apparatus PTR confirms that sheets are set in the selected tray and causes the printing unit 27 to perform a print operation (step S224). Consequently, a print for one page is formed and outputted from the printing apparatus PTR and recorded.

Subsequently, since printing for all the image data is completed at this point, the printing apparatus PTR creates information indicating a print result of the printing and transmits a response “processing result notice” including the information to the destination terminal (step S225).

When a result of judgment at step S221 is “YES”, the printing apparatus PTR confirms that sheets are set in the selected tray and causes the printing unit 27 to perform a print operation (step S226). Consequently, a print for one page is formed and outputted from the printing apparatus PTR and recorded.

The printing apparatus PTR checks whether a value of the counter i is equal to the number of images k (step S227). When a result of judgment at step S227 is “NO”, to perform a print operation for the next page, the printing apparatus PTR proceeds to step S223, increments the value of the counter i by one, and performs processing following step S223.

When a result of judgment at step S227 is “YES”, the printing apparatus PTR proceeds to step S225, creates information indicating a print result of the printing, and transmits a response “processing result notice” including the information to the destination terminal.

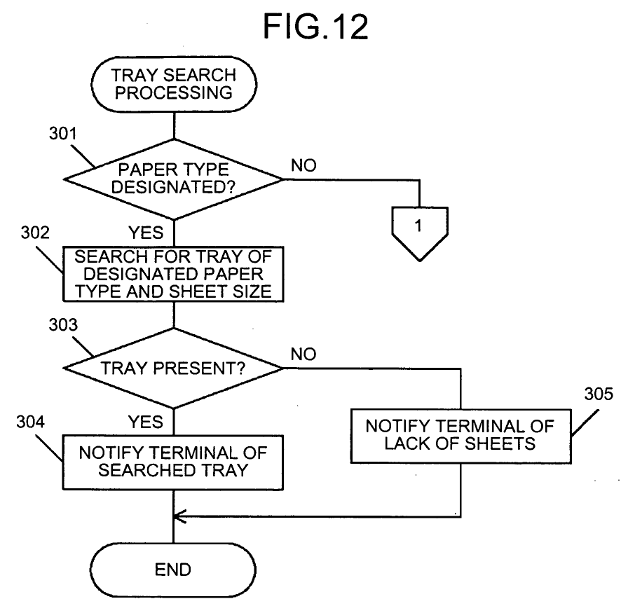

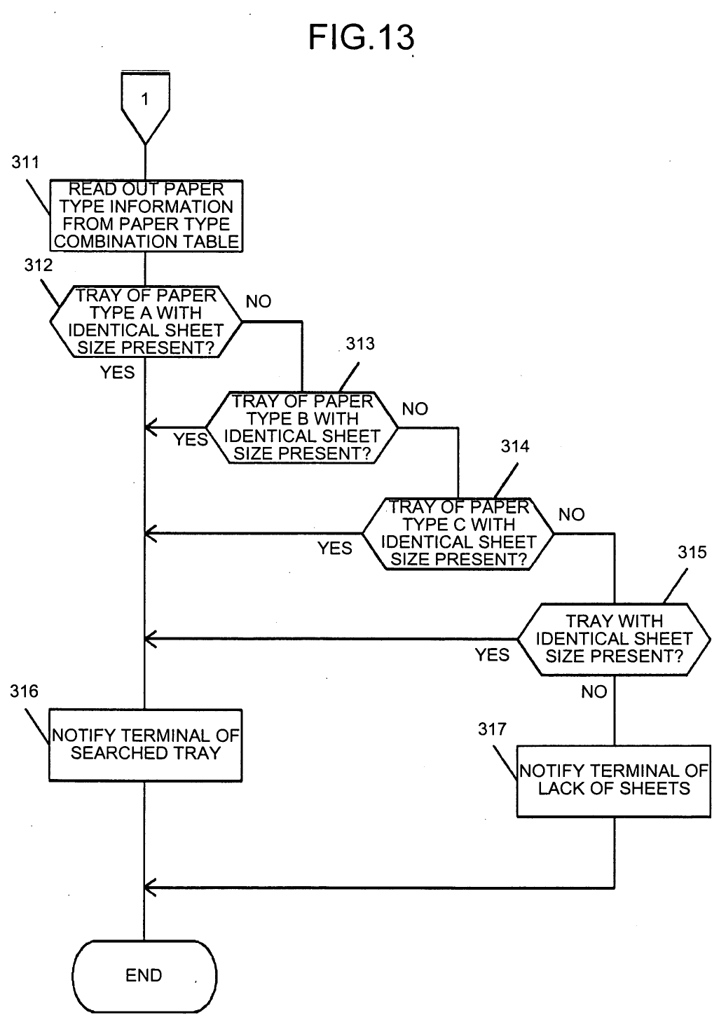

An example of the tray search processing is shown in FIG. 12.

The printing apparatus PTR checks whether information indicating a sheet type is included in print job information (step S301). When a result of judgment at step S301 is “YES”, the printing apparatus PTR checks whether a tray having a size identical with a sheet size notified from the destination terminal and storing sheets of a sheet type designated by the destination terminal is present in the multistage feeding unit 28 (steps S302 and 303).

When a result of judgment at step S303 is “YES”, the printing apparatus PTR notifies the destination terminal of a tray confirmed at that point as the tray searched for (step S304). When a result of judgment at step S303 is NO, the printing apparatus PTR notifies the destination terminal of lack of sheets (step S305).

On the other hand, when information indicating a sheet type is not included in the print job information and a result of judgment at step S311 is “NO”, the printing apparatus PTR extracts actual sheet types corresponding to the sheet types A, B, and C from the sheet type combination table and sets the actual sheet types as the respective sheet types A, B, and C (step S311).

The printing apparatus PTR checks whether a tray of the sheet type A having a size identical with the sheet size notified from the destination terminal is present (step S312). When a result of judgment at step S312 is “NO”, the printing apparatus PTR checks whether a tray of the sheet type B having a size identical with the sheet size notified from the destination terminal is present (step S313). When a result of judgment at step S313 is “NO”, the printing apparatus PTR checks whether a tray of the sheet type C having a size identical with the sheet size notified from the destination terminal is present (step S314). When a result of judgment at step S314 is “NO”, the printing apparatus PTR checks whether a tray having a size identical with the sheet size notified from the destination terminal is present (step S315).

When any one of the results of judgment at steps S312, S313, S314, and S315 is “YES”, the printing apparatus PTR notifies the destination terminal of a tray confirmed at step 312, 313, 314, or 315 as the tray searched for (step S316).

When a result of judgment at step S315 is “NO”, the printing apparatus notifies the destination terminal of lack of sheets (step S317).

According to the present embodiment, in a printing apparatus in which sheets of various sheet types are stored, even if a default value of a sheet type is not changed on a panel or the like or even for a sheet type that cannot be directly designated from a digital still camera, the user can intentionally make it possible to output an image on a sheet of the sheet type by being conscious of priorities of the sheet types.

Since a sheet feeding tray that performs a sheet feeding operation is determined according to such processing, it is also possible to use appropriate output parameters corresponding to a sheet type in a rendering engine unit that actually outputs an image to paper. Thus, it is possible to prevent deterioration in print quality and sheet jam that could occur when, although a designated sheet type is plain paper, an image is forcibly outputted to thick paper.

It is possible to continue rendering processing even if appropriate sheets are not stored in a tray. Thus, it is possible to complete the rendering processing quickly, accept another job, and realize high output throughput.

It is also possible to arbitrarily set priorities of sheet types. This makes it possible to perform search processing for a sheet feeding tray using priorities suitable for preference of a user. Consequently, the user can conveniently output an image to paper of an arbitrary sheet type without being required to perform complicated operation.

According to the present embodiment, the digital still camera or the image storing apparatus is adopted as the external apparatus that is connected to the printing apparatus and supplies image data to the printing apparatus. However, it is also possible to adopt other apparatuses having functions equivalent to these apparatuses as the external apparatus.

According to the present invention, the digital image printing system has a searching unit for a feeding unit based on a state of the feeding unit and priorities of sheet types. Thus, there is an effect that, even in a print job without designation of a sheet type, it is possible to feed a sheet of an arbitrary sheet type to improve convenience of printing.

It is possible to continue rendering processing even if appropriate sheets are not stored in the trays. Thus, there is also an effect that it is possible to accept other jobs and improve throughput of the system.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A digital image printing system built with an external apparatus and a printing apparatus, the external apparatus storing digital image data, making a connection to the printing apparatus, and exchanging data with the printing apparatus, the printing apparatus printing image data received from the external apparatus, wherein
the external apparatus transmits a size of a print sheet and at least one digital image data to the printing apparatus,
the printing apparatus includes
a feeding unit that includes a plurality of trays for storing the print sheet; and
a storing unit that stores a paper-type priority table in which a priority of selection is allocated to a reference sheet type representing a sheet type of the print sheet to be used and a paper-type combination table in which at least one relation between the reference sheet type and an actual sheet type is listed, and
upon receiving the size of the print sheet and the at least one digital image data from the external apparatus, the printing apparatus selects, a tray in which a print sheet of an actual sheet type with a highest priority from among trays in which the print sheet of a same size as the received size by referring to the paper-type priority table and the paper-type combination table, and prints an image of the received digital image data on the print sheet fed from the selected tray.

2. The digital image printing system according to claim 1, wherein
the actual sheet type includes at least a plain paper, a recycled paper, and a special paper.

3. The digital image printing system according to claim 2, wherein
the special paper includes an overhead projector transparency, a backing paper, a color paper, and a thick paper.

4. The digital image printing system according to claim 1, wherein
when a print sheet of a sheet type that is not registered in the paper-type combination table is stored in the feeding unit for the print sheet matching the received size with no other print sheet, the digital image printing system selects a tray in which the print sheet of the sheet type that is not registered in the paper-type combination table.

5. The digital image printing system according to claim 1, wherein
when a print sheet matching the received size is not stored in the feeding unit, the printing apparatus starts a processing for creating print data for the at least one digital image data received from the external apparatus, and displays a guidance message prompting a user to set the print sheet.

6. The digital image printing system according to claim 1, wherein
the size is information indicating a size type of a cut paper.

7. A printing apparatus that makes a connection to an external apparatus to exchange data, and prints image data received from the external apparatus, the printing apparatus comprising:
a feeding unit that includes a plurality of trays for storing the print sheet; and
a storing unit that stores a paper-type priority table in which a priority of selection is allocated to a reference sheet type representing a sheet type of the print sheet to be used and a paper-type combination table in which at least one relation between the reference sheet type and an actual sheet type is listed, wherein
upon receiving a size of the print sheet and at least one digital image data from the external apparatus, the printing apparatus selects, a tray in which a print sheet of an actual sheet type with a highest priority from among trays in which the print sheet of a same size as the received size by referring to the paper-type priority table and the paper-type combination table, and prints an image of the received digital image data on the print sheet fed from the selected tray.

8. The printing apparatus according to claim 7, wherein
the actual sheet type includes at least a plain paper, a recycled paper, and a special paper.

9. The digital image printing system according to claim 8, wherein
the special paper includes an overhead projector transparency, a backing paper, a color paper, and a thick paper.

10. The printing apparatus according to claim 7, wherein
when a print sheet of a sheet type that is not registered in the paper-type combination table is stored in the feeding unit for the print sheet matching the received size with no other print sheet, the digital image printing system selects a tray in which the print sheet of the sheet type that is not registered in the paper-type combination table.

11. The printing apparatus according to claim 7, wherein
when a print sheet matching the received size is not stored in the feeding unit, the printing apparatus starts a processing for creating print data for the at least one digital image data received from the external apparatus, and displays a guidance message prompting a user to set the print sheet.

12. The printing apparatus according to claim 7, wherein
the size is information indicating a size type of a cut paper.

13. A method of controlling a digital image printing system built with an external apparatus and a printing apparatus, the external apparatus storing digital image data, making a connection to the printing apparatus, and exchanging data with the printing apparatus, the printing apparatus printing image data received from the external apparatus, the method comprising:
transmitting including the external apparatus transmitting a size of a print sheet and at least one digital image data to the printing apparatus; and
printing including
the printing apparatus storing a paper-type priority table in which a priority of selection is allocated to a reference sheet type representing a sheet type of the print sheet to be used and a paper-type combination table in which at least one relation between the reference sheet type and an actual sheet type is listed;
the printing apparatus selecting, upon receiving the size of the print sheet and the at least one digital image data from the external apparatus, a tray in which a print sheet of an actual sheet type with a highest priority from among a plurality of trays in which the print sheet of a same size as the received size by referring to the paper-type priority table and the paper-type combination table; and
the printing apparatus printing an image of the received digital image data on the print sheet fed from the selected tray.

14. A method of controlling a printing apparatus that makes a connection to an external apparatus to exchange data, and prints image data received from the external apparatus, the method comprising:
storing a paper-type priority table in which a priority of selection is allocated to a reference sheet type representing a sheet type of a print sheet to be used and a paper-type combination table in which at least one relation between the reference sheet type and an actual sheet type is listed;
selecting, upon receiving a size of the print sheet and at least one digital image data from the external apparatus, a tray in which a print sheet of an actual sheet type with a highest priority from among a plurality of trays in which the print sheet of a same size as the received size by referring to the paper-type priority table and the paper-type combination table; and
printing an image of the received digital image data on the print sheet fed from the selected tray.

15. A computer-readable recording medium that stores a computer program for controlling a printing apparatus that makes a connection to an external apparatus to exchange data, and prints image data received from the external apparatus, wherein
the computer program causes a computer to execute:
storing a paper-type priority table in which a priority of selection is allocated to a reference sheet type representing a sheet type of a print sheet to be used and a paper-type combination table in which at least one relation between the reference sheet type and an actual sheet type is listed;
selecting, upon receiving a size of the print sheet and at least one digital image data from the external apparatus, a tray in which a print sheet of an actual sheet type with a highest priority from among a plurality of trays in which the print sheet of a same size as the received size by referring to the paper-type priority table and the paper-type combination table; and
printing an image of the received digital image data on the print sheet fed from the selected tray.
